(19) United States
(12) Patent Application Publication
(10) Pub. No.: US 2012/0144975 A1
(43) Pub. Date: Jun. 14, 2012

(54) MULTIPURPOSE DRUMSTICK

(76) Inventor: Robert Destocki, Moorpark, CA (US)

(21) Appl. No.: 12/965,923

(22) Filed: Dec. 13, 2010

(51) Int. Cl. G10D 13/02

(52) U.S. Cl. 84/402; 84/422.4

(57) ABSTRACT

The present invention is embodied in a multipurpose instrument system that includes a drumstick configured to incorporate one or more drumstick tips for striking a drum set and a shaker percussion instrument incorporated near the drumstick tips, wherein the drumstick tips are configured to be interchangeable tips or percussion instruments. A coating can be applied to the tip to protect equipment struck by the drumstick and wherein the interchangeable tips can be configured to be flipped by a user to allow the drumstick to perform with various tips and percussion instruments without having to physically switch equipment.

### BACKGROUND

Drums are a percussion instrument that is used in various musical styles. Many drummers perform as the percussion section of a band. The performance may have the drummer physically switching different pieces of equipment during a song such as a traditional drumstick, a shaker such as a maraca and/or a brush while trying to hold down the groove or beat.

### BRIEF DESCRIPTION OF THE DRAWINGS

FIG. 1 shows a block diagram of an overview of a multipurpose drumstick system of one embodiment of the present invention.

FIG. 2 shows a block diagram of an operation of a multipurpose drumstick of one embodiment of the present invention.

FIG. 3A shows a block diagram of a configuration of a multipurpose drumstick with the shaker near the traditional drumstick tip top end and full drumstick coating of one embodiment of the present invention.

FIG. 3B shows a block diagram of a configuration of a multipurpose drumstick with the shaker near the traditional drumstick tip top end and a mallet tip butt end of one embodiment of the present invention.

FIG. 4A shows for illustrative purposes only shows an example of a multipurpose drumstick dowel rod tip end view of one embodiment of the present invention.

FIG. 4B shows a block diagram of a configuration of a multipurpose drumstick with the shaker near a dowel rod tip of one embodiment of the present invention.

FIG. 4C shows a block diagram of a configuration of a multipurpose drumstick with a traditional drumstick tip top end, shaker and a dowel rod tip butt end of one embodiment of the present invention.

FIG. 5A shows for illustrative purposes only shows an example of the multipurpose drumstick traditional drumstick tip and shaker tip configuration of FIG. 1 of one embodiment of the present invention.

FIG. 5B shows for illustrative purposes only shows an example of multipurpose drumstick dowel rod tip and shaker configuration of FIG. 4B of one embodiment of the present invention.

FIG. 6 shows a block diagram of the multipurpose drumstick interchangeable tip system of one embodiment of the present invention.

FIG. 7A shows for illustrative purposes only shows an example of an exploded view of a multipurpose drumstick with a loadable shaker tip and an interchangeable brush tip of one embodiment of the present invention.

FIG. 7B shows for illustrative purposes only shows a section view of an example of a loadable shaker tip of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a multipurpose drumstick, is described for illustrative purposes only and the underlying system can apply to any number and multiple types of drumstick configurations. In one embodiment of the present invention, a multipurpose drumstick can include a traditional drumstick tip top end and a shaker butt end. The multipurpose drumstick is a variable drumstick system and multipurpose drumsticks can be configured with a traditional drumstick tip top end and a shaker located along the drumstick shaft near the top end tip and in other forms, colors, combinations, elements, shapes and sizes using the present invention.

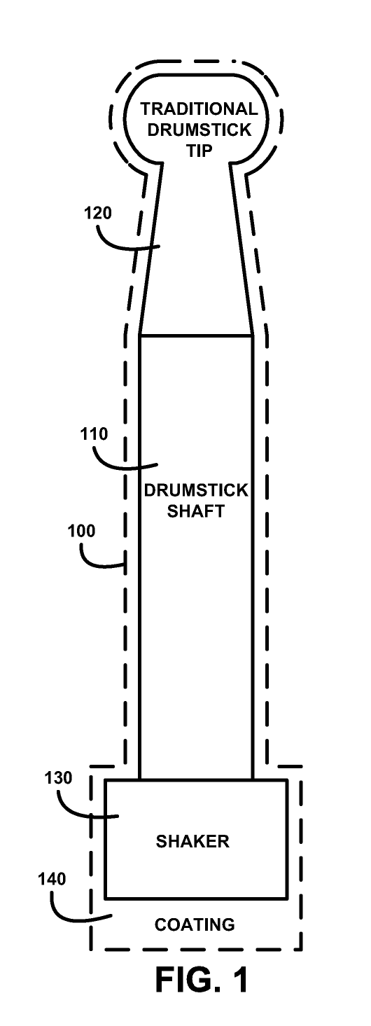

FIG. 1 shows a block diagram of an overview of a multipurpose drumstick system of one embodiment of the present invention. The block diagram in FIG. 1 shows the elements of one configuration of a multipurpose drumstick 100. The example of the multipurpose drumstick 100 shown in FIG. 1 has a drumstick shaft 110 with a traditional drumstick tip 120 positioned at one end of the shaft and a shaker 130 positioned at the opposite end. In this example the assembled multipurpose drumstick 100 elements are covered with a coating 140 of one embodiment of the present invention.

The drummer in a band may perform the drum instrumental using different equipment during portions of a song to create different sounds or even other percussion instruments in sections. This typically involves switching equipment during the performance of a song for example different tips such as hard, softer and/or brushes and even other percussion instruments such as a maraca type shaker. A drummer performing with a pair of multipurpose drumsticks as shown in this example has in hand both pieces of equipment to play the drums and perform shaker or maraca portions of the song. A simple flip of one or both sticks makes the change and thereby the drummer can easily hold down the groove or beat without missing a beat or fumbling for another piece of equipment. The multipurpose drumstick system provides drummers with a choice of multipurpose drumstick configurations to enhance their performance through reducing or eliminating mid song equipment changes of one embodiment of the present invention.

### Detailed Operation:

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

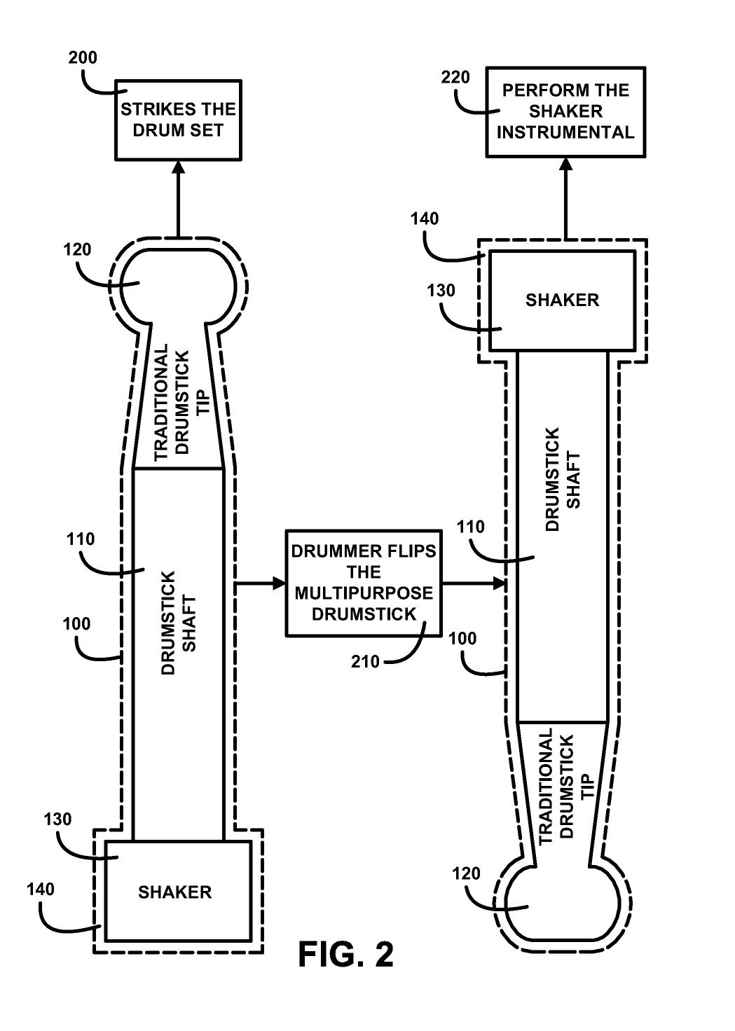

FIG. 2 shows a block diagram of an operation of a multipurpose drumstick of one embodiment of the present invention. FIG. 2 shows the multipurpose drumstick 100 with the drumstick shaft 110 element. The drumstick shaft 110 can be constructed of various materials for example a composite, various species of wood or aluminum. The drumstick shaft 110 can for example be of a solid piece of material or a lamination of multiple materials or a bundling of a group of materials. The two ends of a drum stick are typical referred to as the top end and butt end. Typical drumsticks consist a traditional drumstick tip 120 located at the top end and the shaft extending to the butt end where the drummer holds the stick of one embodiment of the present invention.

The multipurpose drumstick system provides a piece of musical equipment to enable a drummer during the performance of a song to create different drumming sounds and other percussion instrumentals without having to switch equipment. The rhythm in FIG. 2 consists of the drumstick shaft 110 with the traditional drumstick tip 120 positioned at the top end and the shaker 130 at the butt end and completely encased in a durable coating 140. A pair of multipurpose drumstick 100 drumsticks can be held in this position as the drummer strikes the drum set 200. During the song the drummer flips the multipurpose drumstick 210 or both and can perform the shaker instrumental 220 section using the shaker 130. When completed with the section the drummer can quickly and easily flip or twirl the multipurpose drumstick 100 back into position to hit the drum and continue the song without the fuss of physically switching equipment of one embodiment of the present invention.

### Multipurpose Drumstick Configuration Examples:

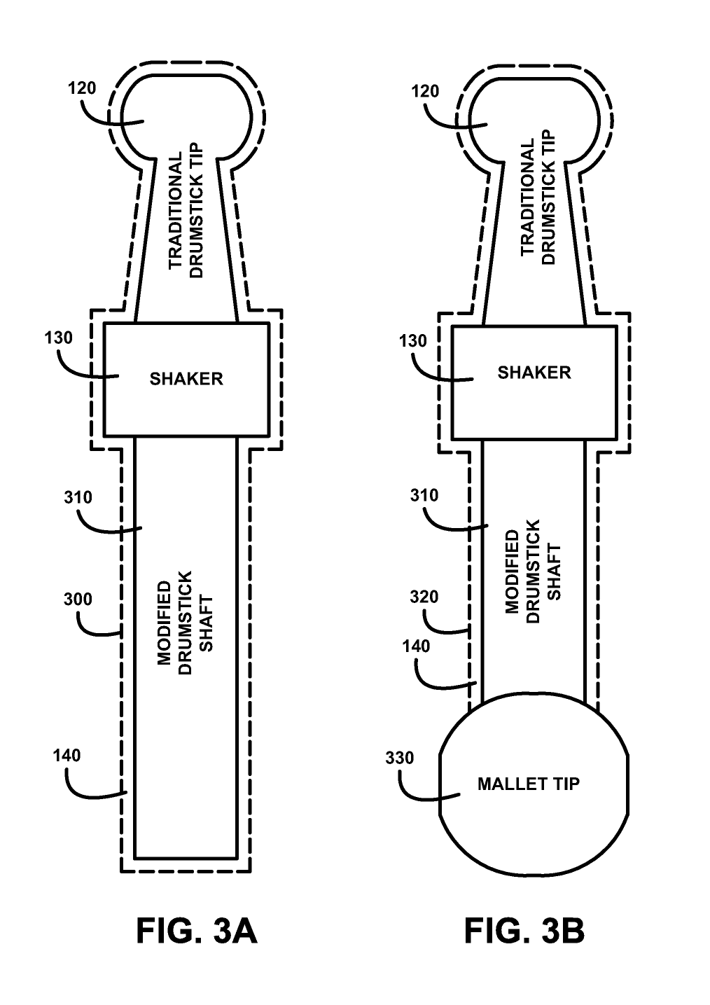

FIG. 3A shows a block diagram of a configuration of a multipurpose drumstick with the shaker near the traditional drumstick tip top end and full drumstick coating of one embodiment of the present invention. The multipurpose drumstick system allows varied configurations for example that shown in FIG. 3A a mid shaft shaker multipurpose drumstick 300 configuration with modified drumstick shaft 310 with a traditional drumstick tip 120 at the top end and a shaker 130 incorporated along the shaft below the traditional drumstick tip 120 with a full coating 140. The traditional drumstick tip 120 can for example be made in a variety of tip shapes such as oval, mushroom, fat, ball, acorn, barrel and round and of a variety of materials such as wood, metal or nylon. The drummer now has the ability to include the shaker 130 in the performance of one embodiment of the present invention.

FIG. 3B shows a block diagram of a configuration of a multipurpose drumstick with the shaker near the traditional drumstick tip top end and a mallet tip butt end of one embodiment of the present invention. The multipurpose drumstick system allows varied configurations for example that shown in FIG. 3B a mid shaft shaker mallet multipurpose drumstick 320 configuration with modified drumstick shaft 310 with a traditional drumstick tip 120 at the top end and a shaker 130 incorporated along the shaft below the traditional drumstick tip 120 with a partial coating 140. The partial coating 140 stops at the mallet tip 330 made of for example soft felt and positioned at the butt end. This configuration provides the drummer with two types of tips with which to strike the drum set producing two distinct sounds with a simple flip and the ability to include the shaker 130 in the performance of one embodiment of the present invention.

### Dowel Drumstick Tip:

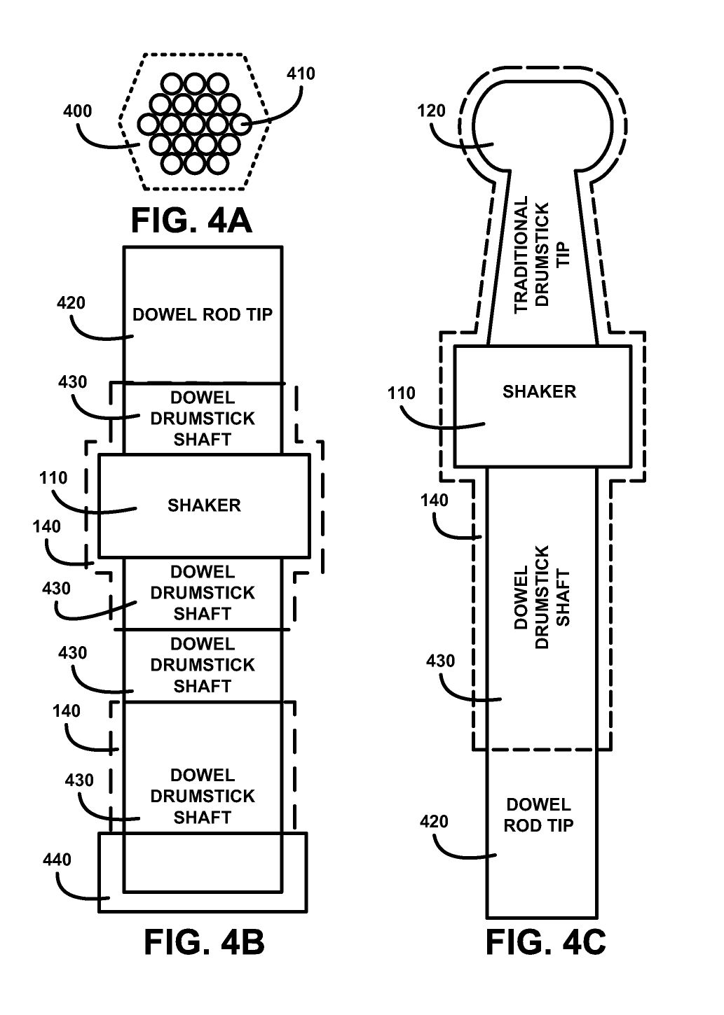

FIG. 4A shows for illustrative purposes only shows an example of a multipurpose drumstick dowel rod tip end view of one embodiment of the present invention. The flexibility in providing multipurpose drumstick configurations of the multipurpose drumstick 100 system includes the use of shaft elements made up of groupings of small dowel rods 400 for example in a hexagonal shape and using materials for example hard wood birch. The sound produced by the small dowel rods 410 hitting the drum is different and desirable by some drummers for various musical styles of one embodiment of the present invention.

FIG. 4B shows a block diagram of a configuration of a multipurpose drumstick with the shaker near a dowel rod tip of one embodiment of the present invention. FIG. 4B shows a multipurpose drumstick 100 of FIG. 1 in a configuration using the groupings of small dowel rods 400 of FIG. 4A to form a dowel rod tip 420 and a dowel drumstick shaft 430. A shaker 130 is positioned along the dowel drumstick shaft 430 below the dowel rod tip 420 and a partial coating 140 is applied to this section of the assembly. The following section of the dowel drumstick shaft 430 is uncoated. Nearing the butt end the dowel drumstick shaft 430 is coated to the end of the shaft. Installed at the butt end is a durable cap 440 of one embodiment of the present invention.

FIG. 4C shows a block diagram of a configuration of a multipurpose drumstick with a traditional drumstick tip top end, shaker and a dowel rod tip butt end of one embodiment of the present invention. In particular, FIG. 4C shows a multipurpose drumstick 100 of FIG. 1 in a configuration using the traditional drumstick tip 120 at the top end followed by the shaker 130 positioned along the dowel drumstick shaft 430 and a partial coating 140 is applied to this section of the assembly stopping near the butt end. The continuing section of dowel drumstick shaft 430 is uncoated leaving the butt end dowel rod tip 420 of one embodiment of the present invention.

### Multipurpose Drumstick Illustrations:

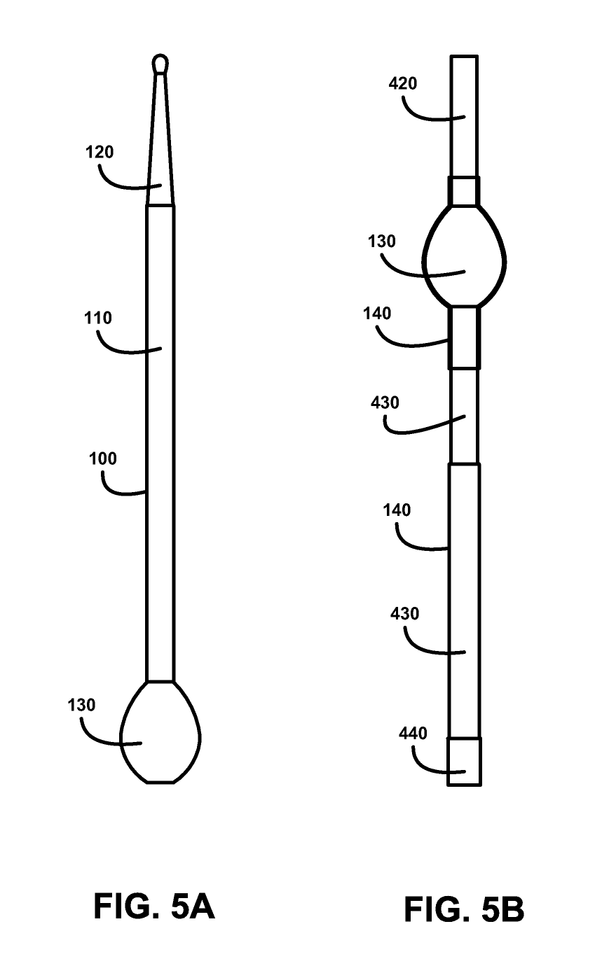

FIG. 5A shows for illustrative purposes only shows an example of the multipurpose drumstick traditional drumstick tip and shaker tip configuration of FIG. 1 of one embodiment of the present invention. An example of the multipurpose drumstick configuration depicted in the block diagram of FIG. 1 is shown in an illustration in FIG. 5A only for the purposes of visualization. The illustration shows the multipurpose drumstick 100 elements of the drumstick shaft 110, a traditional drumstick tip 120 positioned at one end of the shaft and a shaker 130 positioned at the opposite end. Undistinguished in this illustration is the complete coating 140 of FIG. 1 of one embodiment of the present invention.

FIG. 5B shows for illustrative purposes only shows an example of multipurpose drumstick dowel rod tip and shaker configuration of FIG. 4B of one embodiment of the present invention. An example of the multipurpose drumstick configuration depicted in the block diagram of FIG. 4B is shown in an illustration in FIG. 5B only for the purposes of visualization. The illustration shows the multipurpose drumstick configuration with the uncoated dowel rod tip 420 at the top end. Below the uncoated dowel rod tip 420 a coating 140 begins to cover the dowel drumstick shaft 430 and the shaker 130 positioned near the top end. Continuing down the shaft a section is uncoated. Nearing the butt end the coating 140 begins again and covers the remaining section of the dowel drumstick shaft 430 to the butt end. Shown at the butt end is the durable cap 440 of one embodiment of the present invention.

### Interchangeable Tip System:

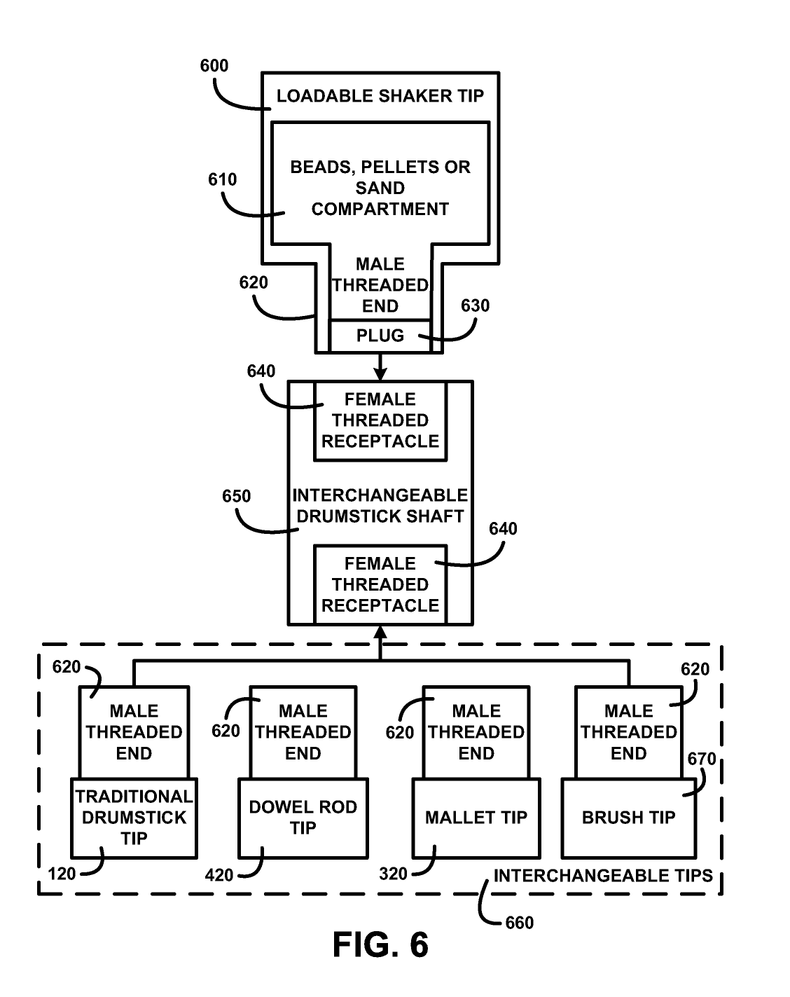

FIG. 6 shows a block diagram of the multipurpose drumstick interchangeable tip system of one embodiment of the present invention. The multipurpose drumstick system provides drummers with the ability to produced different percussion sounds using a set of multipurpose drumsticks configured to relieve the drummer of having to physically change equipment during the performance of a song. One of the novel features of the multipurpose drumstick system is the interchangeable tip system.

In one embodiment, FIG. 6 shows an interchangeable drumstick shaft 650 that is configured with a female threaded receptacle 640 at both the top and butt ends of the shaft. The interchangeable tip system includes for example various tips configured with a male threaded end 620 which allows them to be twisted or screwed into the female threaded receptacle 640 ends of the interchangeable drumstick shaft 650. The interchangeable tips 660 include for example a traditional drumstick tip 120, which can be configured in a variety of shapes and materials, a dowel rod tip 420, a mallet tip 330, a brush tip 670 and a loadable shaker tip 600. This allows the drummer to choose from the assortment of tips for each song. The adaptability provided by the multipurpose drumstick interchangeable tip system allows the drummer to quickly be ready to produce the desired sounds from song to song while maintaining the ease of use of different equipment with a simple flip enabled with multipurpose drumstick system of one embodiment of the present invention.

The loadable shaker tip 600 expands the adaptation of producing different sounds by allowing the drummer to change the material inside the loadable shaker tip 600. A beads, pellets or sand compartment 610 in the head of the loadable shaker tip 600 can be filled with different materials to produce different sounds. The loadable shaker tip 600 has a male threaded end 620 where the opening of the beads, pellets or sand compartment 610 is located. The beads, pellets or sand placed inside are held in place using a plug 630 inserted into the male threaded end 620 of one embodiment of the present invention.

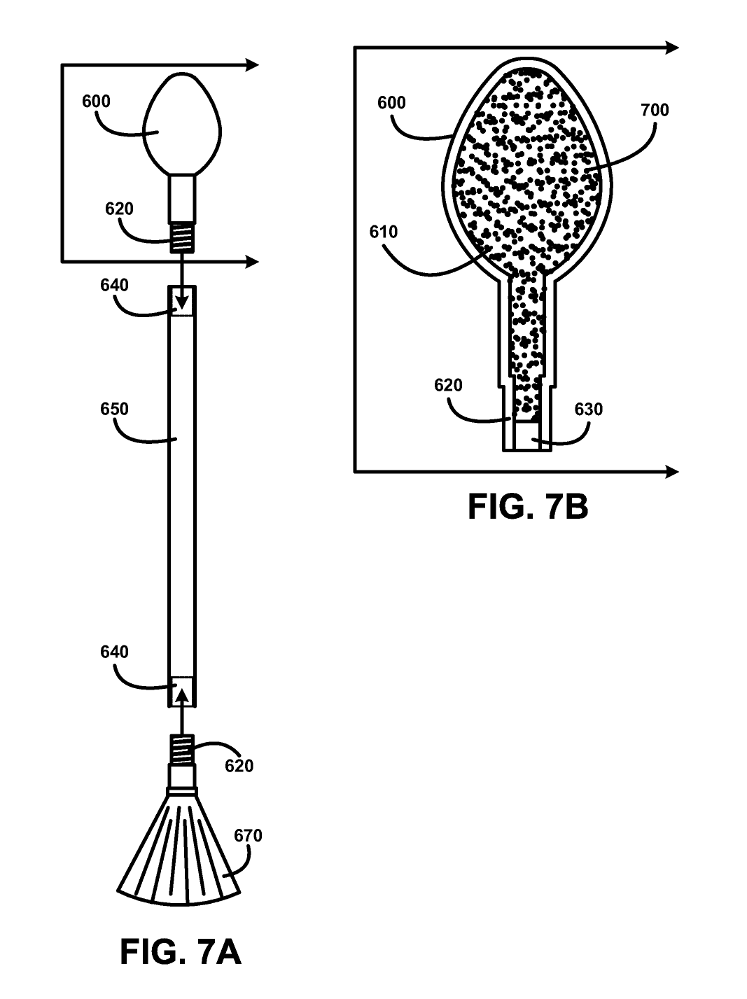

FIG. 7A shows for illustrative purposes only shows an example of an exploded view of a multipurpose drumstick with a loadable shaker tip and an interchangeable brush tip of one embodiment of the present invention. To illustrate the adaptability of the multipurpose drumstick using the interchangeable tip system feature. Shown in FIG. 7A is the interchangeable drumstick shaft 650 with female threaded receptacle 640 ends. Into one end is inserted a loadable shaker tip 600 with a male threaded end 620. The interchangeable brush tip 670 is inserted into the other end using the male threaded end 620 of one embodiment of the present invention.

### Loadable Shaker Tip:

FIG. 7B shows for illustrative purposes only shows a section view of an example of a loadable shaker tip of one embodiment of the present invention. An example of the loadable shaker tip 600 depicted in the block diagram of FIG. 6 is shown in an illustration in FIG. 7B only for the purposes of visualization. A quick change of the material inside the loadable shaker tip 600 can be made using beads, pellets or sand 700. The beads, pellets or sand compartment 610 in the head of the loadable shaker tip 600 can be filled with different materials by removing the plug 630 removing any prior material and refilling with a new material to produce different sounds. The plug 630 is reinserted into the male threaded end 620 and the loadable shaker tip 600 screwed into the interchangeable shaft of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A multipurpose instrument system, comprising:
a drumstick having one or more drumstick tips for striking a drum set; and
a shaker percussion instrument incorporated proximate to the drumstick tips;
wherein the drumstick tips are configured to be interchangeable percussion tip instruments;
wherein a coating is applied to each tip to protect equipment struck by the drumstick;
wherein the interchangeable tips are configured to be flipped by a user;
wherein the drumstick are configured to be used with various tips and percussion instruments without having to physically switch equipment.

2. The multipurpose instrument system of claim 1, wherein the drumstick includes one or more traditional drumstick tips configured in at least one of various shapes, including oval, mushroom, fat, ball, acorn, barrel or round.

3. The multipurpose instrument system of claim 1, wherein the drumstick includes one or more traditional drumstick tips configured of at least one of wood, metal or nylon.

4. The multipurpose instrument system of claim 1, wherein a shaft of the drumstick is constructed of a composite material.

5. The multipurpose instrument system of claim 1, wherein a shaft of the drumstick is constructed as at least one of a solid piece of material, a lamination of multiple materials or a bundling of a group of materials.

6. The multipurpose instrument system of claim 1, wherein a shaft of the drumstick is constructed of at least one of various species of wood or aluminum.

7. The multipurpose instrument system of claim 1, wherein the drumstick includes a shaker percussion instrument at one end in a position along the drumstick shaft and includes a traditional drumstick tip at another end opposite the one end.

8. The multipurpose instrument system of claim 1, wherein the drumstick is includes a shaker in a position along the drumstick shaft, a traditional drumstick tip at one end and a mallet tip at another other end opposite the one end.

9. The multipurpose instrument system of claim 1, wherein the drumstick includes a shaker in a position along the drumstick shaft, a traditional drumstick tip at one end and a dowel rod tip at the another end opposite the one end.

10. The multipurpose instrument system of claim 1, wherein the drumstick includes a shaker in a position along the drumstick shaft, a traditional drumstick tip at one end and a brush tip at the another end opposite the one end.

11. The multipurpose instrument system of claim 1, wherein the drumstick includes a coating to protect the drumstick assembly and applied with a fast drying acrylic based vinyl material.

12. A method for creating adaptable multipurpose drumstick percussion equipment, comprising:
creating an interchangeable drumstick shaft with two ends, the drumstick shaft including female threaded receptacles at the two ends of the shaft;
creating interchangeable drumstick tips with male threaded ends to allow attachment to the female threaded receptacles at two ends of the interchangeable drumstick shaft; and
creating various percussion instruments as interchangeable tips with male threaded ends to allow attachment to the female threaded receptacles at the two ends of the interchangeable drumstick shaft.

13. The method of claim 12, wherein the interchangeable drumstick tips with male threaded ends include traditional drumstick tips that are configured as at least one of a dowel rod tip, a mallet tip and a brush tip.

14. The method of claim 12, wherein the interchangeable percussion instrument tips with male threaded ends are configured to include percussion instruments as an interchangeable shaker tip.

15. An interchangeable loadable shaker tip apparatus configured as a percussion instrument, comprising
an interchangeable drumstick shaft;
a loadable shaker tip head coupled to the interchangeable drumstick shaft, wherein the loadable shaker tip having a hollow compartment configured to hold bead, pellet, or sand shaking materials;
a male threaded end with a hollowed stem for insertion of a plug, wherein the male threaded end configured to be attached to a female threaded receptacle on the interchangeable drumstick shaft; and
a removable plug configured to retain the shaking materials within the hollow compartment of the loadable shaker tip head and configured to be inserted into the hollowed stem male threaded end.
